(19) United States
(12) Patent Application Publication
(10) Pub. No.: US 2024/0375222 A1
(43) Pub. Date: Nov. 14, 2024

(54) UNIVERSAL DYNAMIC BEAM SHAPER

(71) Applicant: Orbotech Ltd., Yavne (IL)

(72) Inventors: Roman Vander, Gedera (IL); Boris Kling, Rehovot (IL); Alexey Shkolnik, Yavne (IL); Idan Amsalem, Yavne (IL)

(21) Appl. No.: 18/315,998

(22) Filed: May 11, 2023

(51) Int. Cl. B23K 26/382; B23K 26/073; G02B 27/09; G02F 1/11

(52) U.S. Cl. CPC B23K 26/382; B23K 26/073; G02B 27/0927; G02F 1/113; G02F 1/116; B23K 2101/36; G02F 2203/26

(57) ABSTRACT

A micromachining system includes a laser generator, an acousto-optical deflector (AOD), and at least one signal generator. The laser generator is configured to generate a laser beam, and the at least one AOD is positioned in a path of the laser beam. The at least one acoustic signal generator is configured to generate at least two acoustic signals, including a first acoustic signal having a periodic waveform and a second acoustic signal having a freeform waveform. The at least one acoustic signal generator is further configured to apply the first acoustic signal to the AOD to output a deflected laser beam having a Gaussian profile, and apply the second acoustic signal to the AOD to adjust the Gaussian profile of the deflected laser beam to a modified profile.

### FIELD OF THE DISCLOSURE

This disclosure relates to laser beams used for semiconductor manufacturing.

### BACKGROUND OF THE DISCLOSURE

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer that are separated into individual semiconductor devices.

During the fabrication process, micromachining processes may be performed on a semiconductor wafer or substrate using a laser. As dimensions of semiconductor devices decrease, the size of micro-machined features also decrease, and the dimensions and accuracy of the laser become more important to the successful manufacture of acceptable semiconductor devices. In an exemplary micromachining process, a laser is used to cut holes and other features into the substrate. The laser may have a Gaussian beam shape that is suitable for cutting some features, but other features may require a beam having a different shape. In order to change the beam shape, optical elements in the system must be moved, which adds time to the fabrication process. When multiple switches between types of beam shapes is required for a specific application scenario, throughput time is further lost. For example, existing methods would require cutting all holes in the substrate using a first beam shape, and then cutting all holes in the substrate with a second beam shape, or moving optics to switch beam shapes between each hole cut, which can more than double the time of the fabrication process.

In addition, the range of beam shapes available for laser cutting is limited by the system optics, which are, in turn, limited by their size and movability within the system to produce different beam shapes. In some applications, the beam shapes required for a micro-machining process may be highly specific and may require specific optical components to produce a desired beam shape. Thus, preparation time may be needed for system set up and to modify the available beam shapes.

Therefore, what is needed is a method to more efficiently change the laser beam shape for improved semiconductor manufacturing.

### BRIEF SUMMARY OF THE DISCLOSURE

An embodiment of the present disclosure provides a system comprising a laser generator, an acousto-optical deflector (AOD), and at least one acoustic signal generator. The laser generator may be configured to generate a laser beam, and the AOD may be positioned in a path of the laser beam. The at least one acoustic signal generator may be configured to generate at least two acoustic signals comprising a first acoustic signal having a periodic waveform and a second acoustic signal having a freeform waveform. The at least one acoustic signal generator may be further configured to apply the first acoustic signal to the AOD to output a deflected laser beam having a Gaussian profile, and apply the second acoustic signal to the AOD to adjust the Gaussian profile of the deflected laser beam to a modified profile.

According to an embodiment of the present disclosure, the modified profile may comprise a top hat profile or a multi-pole profile.

According to an embodiment of the present disclosure, the at least one acoustic signal generator may comprise a first signal generator and a second signal generator. The first signal generator may be configured to generate the first acoustic signal, and the second signal generator may be configured to generate the second acoustic signal. The first signal generator and the second signal generator may be configured to apply one of the first acoustic signal and the second acoustic signal to the AOD at a time.

According to an embodiment of the present disclosure, the at least one acoustic signal generator may comprise a single signal generator. The single signal generator may be configured to generate both the first acoustic signal and the second acoustic signal. The single signal generator may be configured to apply one of the first acoustic signal and the second acoustic signal to the AOD at a time.

According to an embodiment of the present disclosure, the laser beam may be a pulsed laser beam having a time period between laser pulses. The at least one acoustic signal generator may be further configured to switch between generating the first acoustic signal and the second acoustic signal during the time period between laser pulses.

According to an embodiment of the present disclosure, the system may further comprise a stage. The stage may be configured to hold a substrate positioned in a path of the deflected laser beam.

According to an embodiment of the present disclosure, the system may further comprise a second AOD. The second AOD may be positioned in the path of the laser beam orthogonal to the AOD. The at least one acoustic signal generator may be further configured to apply the first acoustic signal and the second acoustic signal to the second AOD to produce two-dimensional beam profiles.

According to an embodiment of the present disclosure, the AOD may comprise a crystal. Applying the at least two acoustic signals to the crystal may modify a diffractive grating created in the crystal by the acoustic wave to output the deflected laser beam having the Gaussian profile and the modified profile. A frequency of the at least two acoustic signals may define an angle of the deflected laser beam, and an amplitude of the at least two acoustic signals may define an intensity of the deflected laser beam. The freeform waveform may have a non-periodic frequency and amplitude that is configured to adjust the Gaussian profile of the deflected laser beam to the modified profile.

An embodiment of the present disclosure provides a method comprising directing a laser beam toward an acousto-optical deflector (AOD); generating at least two acoustic signals comprising a first acoustic signal having a periodic waveform and a second acoustic signal having a freeform waveform; applying the first acoustic signal to the AOD to output a deflected laser beam having a Gaussian profile; and applying the second acoustic signal to the AOD to adjust the Gaussian profile of the deflected laser beam to a modified profile.

According to an embodiment of the present disclosure, generating the at least two acoustic signals may comprise: generating the first acoustic signal with a first signal generator; and generating the second acoustic signal with a second signal generator after applying the first acoustic signal to the AOD.

According to an embodiment of the present disclosure, generating the at least two acoustic signals may comprise: generating the first acoustic signal and the second acoustic signal with a single signal generator; and after applying the first acoustic signal to the AOD, the single signal generator switches to generate the second acoustic signal instead of the first acoustic signal.

According to an embodiment of the present disclosure, the laser beam may be a pulsed laser beam having a time period between laser pulses, and the time between applying the first acoustic signal to the AOD and applying the second acoustic signal to the AOD is less than the time period between laser pulses.

According to an embodiment of the present disclosure, the method may further comprise: directing the deflected laser beam toward a stage configured to hold a substrate; and cutting a hole in the substrate with the deflected laser beam. Cutting the hole in the substrate with the deflected laser beam may comprise: cutting the hole in the substrate with the deflected laser beam having the Gaussian profile; and cutting the hole in the substrate with the deflected laser beam having the modified profile.

### DESCRIPTION OF THE DRAWINGS

For a fuller understanding of the nature and objects of the disclosure, reference should be made to the following detailed description taken in conjunction with the accompanying drawings, in which:

FIG. 1 is a schematic diagram of a system according to an embodiment of the present disclosure in a configuration for outputting a laser beam having a Gaussian profile;

FIG. 2 is a schematic diagram of the system of FIG. 1 in a configuration for outputting a laser beam having a modified profile;

FIG. 3A is an exemplary Gaussian profile of a laser beam;

FIG. 3B is an exemplary Gaussian profile of a laser beam in three dimensions;

FIG. 3C is an exemplary top hat profile of a laser beam;

FIG. 3D is an exemplary top hat profile of a laser beam in three dimensions;

FIG. 3E is an exemplary dipole profile of a laser beam;

FIG. 3F is an exemplary dipole profile of a laser beam showing the two-dimensional 2×2 arrangement;

FIG. 4 is a schematic diagram of a system according to another embodiment of the present disclosure in a configuration for outputting a laser beam having a Gaussian profile;

FIG. 5 is a schematic diagram of the system of FIG. 4 in a configuration for outputting a laser beam having a modified profile;

FIG. 6 is a flowchart of a method according to an embodiment of the present disclosure;

FIG. 7 is a flowchart of further detailed steps of the method of FIG. 6;

FIG. 8 is a flowchart of further detailed steps of the method of FIG. 6; and

FIG. 9 is a schematic diagram of a system according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process, step, and electronic changes may be made without departing from the scope of the disclosure. Accordingly, the scope of the disclosure is defined only by reference to the appended claims.

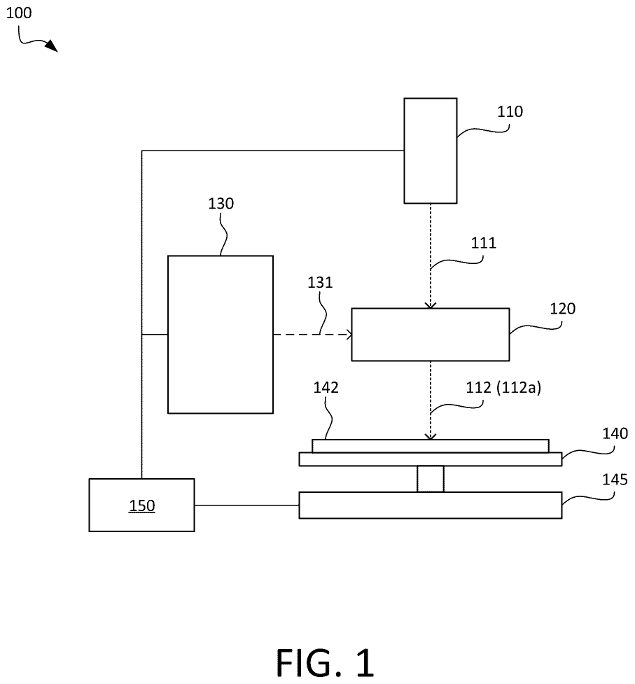

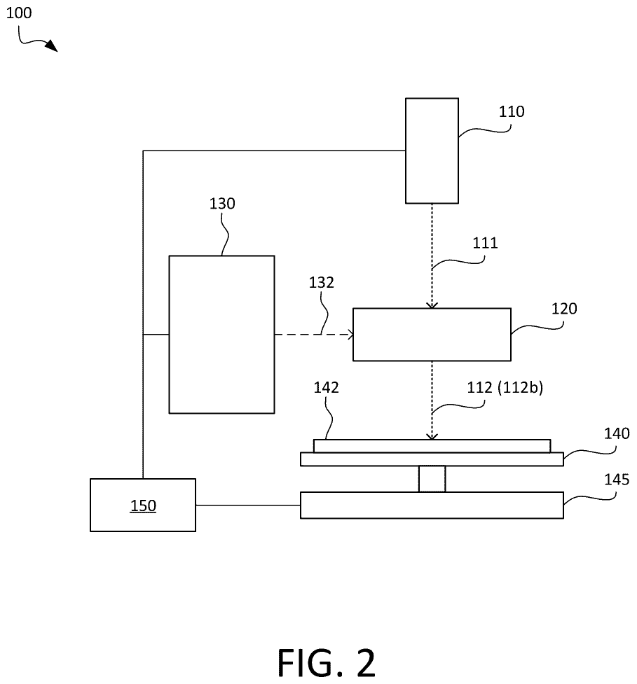

An embodiment of the present disclosure provides a system 100, shown in FIG. 1 and FIG. 2. The system 100 may comprise a laser generator 110. The laser generator 110 may be configured to generate a laser beam 111. The laser generator 110 may have a power of 20 W to 30 W, and may be configured to generate a laser beam 111 having an intensity capable of performing a cutting operation on a substrate. The laser generator 110 may be selected based the materials of the substrate sought to be cut. The laser beam 111 may be a pulsed laser beam. The pulsed laser beam may have a pulse width and a time period between laser pulses, which may be set according to the application.

The system 100 may further comprise an acousto-optical deflector (AOD) 120. The AOD 120 may be positioned in the path of the laser beam 111. The AOD 120 may be a crystal that is configured to output a deflected laser beam 112. When an acoustic signal is applied to the AOD 120, the diffractive grating created in the crystal by the acoustic wave may be modified to adjust the profile of the deflected laser beam 112. For example, a frequency of an acoustic signal may define an angle of the deflected laser beam 112, and an amplitude of an acoustic signal may define an intensity of the deflected laser beam 112. It should be understood that when no acoustic signal is applied to the AOD 120, the laser beam 111 may be transmitted through the AOD, and there may be no deflection. So called “zero-order” beams may be directed toward a beam dump.

The system 100 may further comprise at least one acoustic signal generator 130. The at least one acoustic signal generator 130 may be configured to generate at least two acoustic signals. The at least one signal generator 130 may comprise a combination of electrical circuits, processors, and/or other electrical components that are configured to generate the at least two acoustic signals. The at least two acoustic signals may comprise a first acoustic signal 131 and a second acoustic signal 132. The first acoustic signal 131 may have a periodic waveform, and the second acoustic signal 132 may have a freeform waveform.

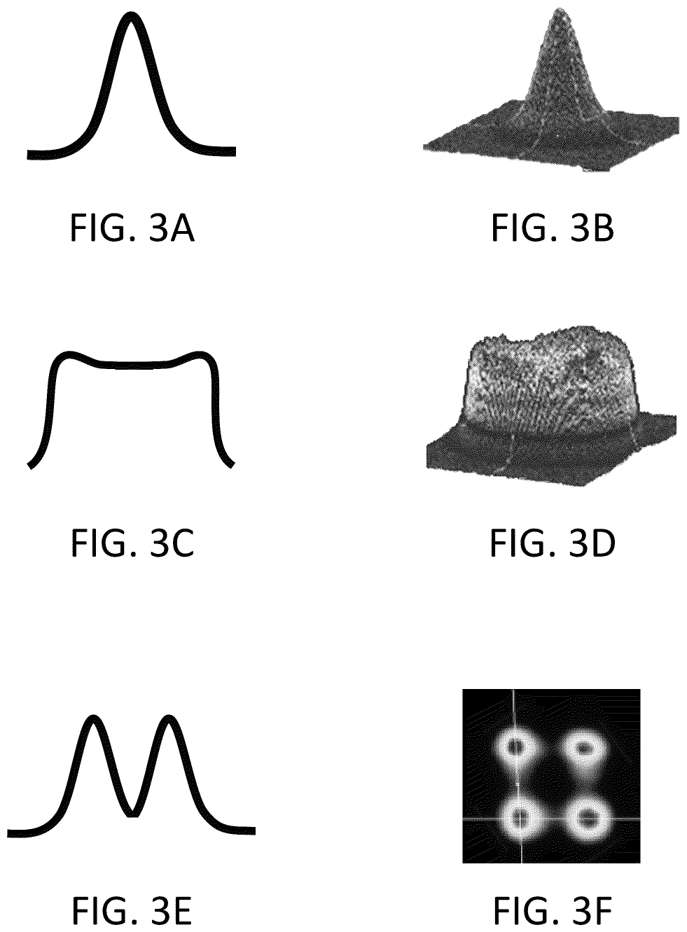

The at least one acoustic signal generator 130 may be configured to apply the first acoustic signal 131 to the AOD 120. The first acoustic signal 131 may propagate through the AOD 120 and cross an optical aperture of the AOD 120, through which the laser beam 111 is transmitted. When the first acoustic signal 131 is applied to the AOD 120, the deflected laser beam 112 may have a Gaussian profile 112a. Exemplary Gaussian profiles are shown in FIG. 3A and FIG. 3B.

The at least one acoustic signal generator 130 may be further configured to apply the second acoustic signal 132 to the AOD 120. The second acoustic signal 132 may propagate through the AOD 120 and cross the optical aperture of the AOD 120, through which the laser beam 111 is transmitted. When the second acoustic signal 132 is applied to the AOD 120, the Gaussian profile 112a of the deflected laser beam 112 may be adjusted to a modified profile 112b. As further described herein, the modified profile 112b may define a laser beam shape that is different from the Gaussian profile 112a. For example, the modified profile 112b may comprise a top hat profile, an annular profile, or a multipole profile (e.g., dipole, tripole, quadrupole, etc.). Exemplary top hat profiles are shown in FIG. 3C and FIG. 3D, and exemplary dipole profiles are shown in FIG. 3E and FIG. 3F.

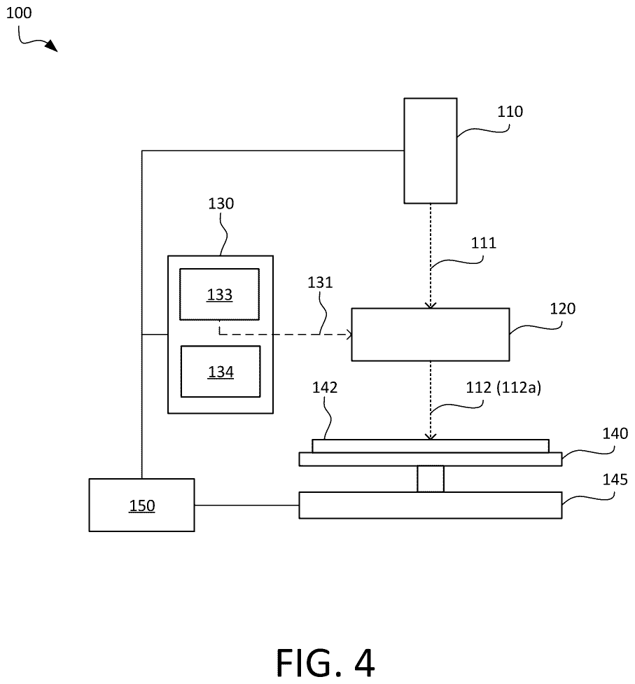

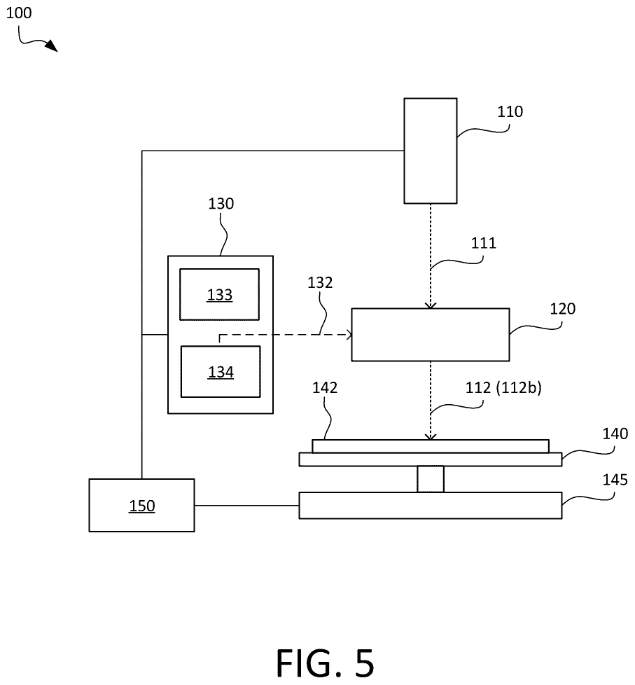

According to an embodiment of the present disclosure shown in FIG. 4 and FIG. 5, the at least one acoustic signal generator 130 may comprise a first signal generator 133 and a second signal generator 134. The first signal generator 133 may be configured to generate the first acoustic signal 131, and the second signal generator 134 may be configured to generate the second acoustic signal 132. Only one of the first signal generator 133 and the second signal generator 134 may be configured to apply an acoustic signal to the AOD 120 at a time. In other words, the Gaussian profile 112a of the deflected laser beam 112 may be adjusted to the modified profile 112b by switching from the first signal generator 133 applying the first acoustic signal 131 to the AOD 120 (shown in FIG. 4) to the second signal generator 134 applying the second acoustic signal 132 to the AOD 120 (shown in FIG. 5). In some embodiments, the at least one acoustic signal generator 130 may comprise additional signal generators to generate additional acoustic signals and produce different beam shapes. Alternatively, the second signal generator 134 may be configured to generate the second acoustic signal 132 and additional acoustic signals to produce different beam shapes.

According to an embodiment of the present disclosure, the at least one acoustic signal generator 130 may comprise a single signal generator 130 that is configured to generate both the first acoustic signal 131 and the second acoustic signal 132. The single signal generator 130 may be configured to generate only one of the first acoustic signal 131 and the second acoustic signal 132 at a time. In other words, the Gaussian profile 112a of the deflected laser beam 112 may be adjusted to the modified profile 112b by switching from generating the first acoustic signal 131 to the second acoustic signal 132 and applying the second acoustic signal 132 to the AOD 120. The single signal generator 130 may be configured to generate additional acoustic signals to produce different beam shapes.

The system 100 may further comprise a stage 140. The stage 140 may be configured to hold a substrate 142. The substrate 142 may be a semiconductor wafer, printed circuit board, or other components. When disposed on the stage 140, the substrate 142 may be positioned in a path of the deflected laser beam 112. For example, at least a portion of the substrate 142 may be positioned in the path of the deflected laser beam 112. Accordingly, the deflected laser beam 112 may be configured to perform micro-machining processes on the substrate 142. For example, the deflected laser beam 112 may cut a hole in the substrate 142. It should be understood that the Gaussian profile 112a or the modified profile 112b of the deflected laser beam 112 may produce different hole geometries, and may be suitable for different applications. In some embodiments, a hole may be first cut with the deflected laser beam 112 having a Gaussian profile 112a, and may be subsequently cut with the deflected laser beam 112 having a modified profile 112b. By cutting the same hole with deflected laser beams 112 having both beam profiles, certain hole geometries may be cut more easily or accurately (compared to a single cut with one beam profile). The stage 140 may be movable by a positioning system 145, which can modify the xyz position of the substrate 142 relative to the deflected laser beam 112. Thus, in some embodiments, a hole may be first cut with the deflected laser beam 112 having a Gaussian profile 112a in a first location on the substrate 142, and the positioning system 145 may move the substrate 142 to cut a hole with the deflected laser beam 112 having a modified profile 112b in a second location on the substrate 142.

The system 100 may further comprise a processor 150. The processor 150 may include a microprocessor, a microcontroller, or other devices.

The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. A micromachining tool can receive instructions or other information from the processor 150. The processor 150 optionally may be in electronic communication with a wafer inspection tool, a wafer metrology tool, or a wafer review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 and may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

In some embodiments, the processor 150 may be configured to control the laser generator 110 to generate the laser beam 111. For example, the processor 150 may be configured to turn on/off the laser generator 110 and/or adjust the parameters of the laser beam 111 (e.g., pulse width, time between laser pulses). The processor 150 may be further configured to turn on/off a shutter, control Galvano scanners, and move motorized optical elements in the path of the laser beam 111.

The processor 150 may be further configured to control the at least one acoustic signal generator 130 to generate the at least two acoustic signals. For example, the processor 150 may be configured to control the first signal generator 133 to generate the first acoustic signal 131 and to control the second signal generator 134 to generate the second acoustic signal 132. In some embodiments, the processor 150 may be configured to control the single signal generator 130 to control the first acoustic signal 131 and the second acoustic signal 132.

The processor 150 may be configured to control the frequency and amplitude of the first acoustic signal 131. As a periodic waveform, the first acoustic signal 131 may have a fixed frequency and amplitude, defining a sinewave-like signal. Such a waveform produces the deflected laser beam 112 having a Gaussian profile 112a with the angle and intensity set by the frequency and amplitude defined by the processor 150. In some embodiments, the first acoustic signal 131 may have a frequency of 10 to 100 MHz.

The processor 150 may be further configured to control the frequency and amplitude of the second acoustic signal 132. As a freeform waveform, the second acoustic signal 132 may be defined piecemeal by the frequency and amplitude of a combination of signals. For example, the frequency and amplitude of the signal may be set for a period of time (i.e., “zone”) of the waveform in the time domain. By piecing together multiple zones having different frequencies and/or amplitudes, the freeform waveform can be defined. Such a waveform produces the deflected laser beam 112 having a modified profile 112b with the angle and intensity set by the frequency and amplitude of each zone defined by the processor 150. The spatial resolution of the freeform waveform (i.e., the number of zones that define the waveform) may limit the modification of the beam profile and available beam shapes. The freeform waveform may have at least two zones, and the spatial resolution of the freeform waveform may increase as the number of zones increases (but the computational requirements of the processor 150 also increase). In a particular embodiment, a freeform waveform having up to 10 zones may produce modified profiles 112b (e.g., top hat profile, multipole profiles) suitable for micro-machining operations on a semiconductor substrate.

The processor 150 may also be configured to control the position of the stage 140 and movement velocity of the stage 140, to change the position where the deflected laser beam 112 impacts the substrate 142.

With the system 100, the shape of the deflected laser beam 112 can be controlled easily and quickly by applying different acoustic signals to the AOD 120. This may increase system flexibility to produce desired beam shapes moving or modifying optics or other system components. In addition, throughput time may be reduced, as beam shape can be changed in microseconds (e.g., between laser pulses), instead of moving optics or moving the positioning system 145 to repeat cutting operations.

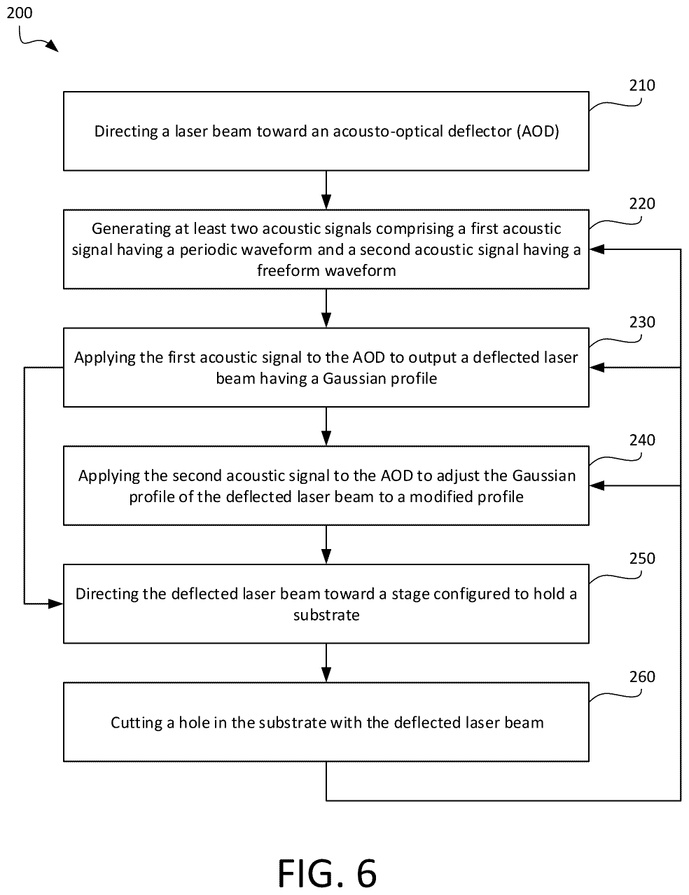

Another embodiment of the present disclosure provides a method 200. As shown in FIG. 6, the method may include the following steps.

At step 210, a laser beam is directed toward an acousto-optical deflector (AOD). The laser beam may be generated by a laser generator. The laser generator may have a power of 20 W to 30 W, and may be configured to generate a laser beam having an intensity capable of performing cutting operations on a substrate. The laser generator may be selected based on the materials of a substrate sought to be cut. The laser beam may be a pulsed laser beam. The pulsed laser beam may have a pulse width and a time period between laser pulses, which may be set for the particular application.

The AOD may be positioned in the path of the laser beam. The AOD may be a crystal that is configured to output a deflected laser beam. When an acoustic signal is applied to the AOD, the diffractive grating created in the crystal by the acoustic wave may be modified to adjust the profile of the deflected laser beam. For example, a frequency of an acoustic signal may define an angle of the deflected laser beam, and an amplitude of an acoustic signal may define an intensity of the deflected laser beam.

At step 220, at least two acoustic signals are generated. At least one signal generator may be configured to generate a first acoustic signal and a second acoustic signal. The first acoustic signal may have a periodic waveform, and the second acoustic signal may have a freeform waveform.

At step 230, the first acoustic signal is applied to the AOD to output a deflected laser beam having a Gaussian profile. Exemplary Gaussian profiles are shown in FIG. 3A and FIG. 3B. The first acoustic signal may propagate through the AOD and cross an optical aperture of the AOD, through which the laser beam is transmitted.

At step 240, the second acoustic signal is applied to the AOD to adjust the Gaussian profile of the deflected laser beam to a modified profile. The second acoustic signal may propagate through the AOD and cross the optical aperture of the AOD, through which the laser beam is transmitted. As further described herein, the modified profile may define a laser beam shape that is different from the Gaussian profile. For example, the modified profile may comprise a top hat profile, an annular profile, or a multi-pole profile (e.g., dipole, tripole, quadrupole, etc.). Exemplary top hat profiles are shown in FIG. 3C and FIG. 3D, and exemplary dipole profiles are shown in FIG. 3E and FIG. 3F.

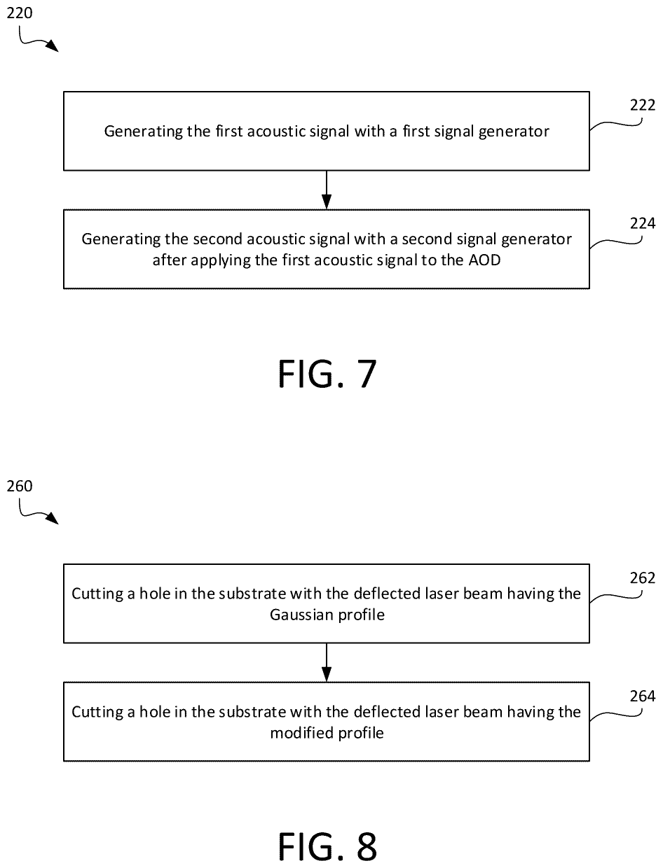

According to an embodiment of the present disclosure, the first acoustic signal may be generated by a first signal generator, and the second acoustic signal may be generated by a second signal generator. As shown in FIG. 7, step 220 may comprise the following steps.

At step 222, the first acoustic signal is generated with the first signal generator. After generating the first acoustic signal, step 230 may be performed, i.e., the first acoustic signal is applied to the AOD to output the deflected laser beam having the Gaussian profile.

At step 224, the second acoustic signal is generated with the second signal generator, after applying the first acoustic signal to the AOD. After generating the second acoustic signal, step 240 may be performed, i.e., the second acoustic signal is applied to the AOD to adjust the Gaussian profile of the deflected laser beam to the modified profile.

In some embodiments, steps 222 and 224 may be performed at the same time, but only one of steps 230 and 240 may be performed at a time. In other words, performing steps 230 and 240 may switch which of the first acoustic signal and the second acoustic signal is applied to the AOD at a time, after the first signal generator and the second signal generator generated the respective acoustic signals in steps 222 and 224. Alternatively, step 222 may be performed before step 230, and step 224 may be performed before step 240.

According to an embodiment of the present disclosure, the first acoustic signal and the second acoustic signal may be generated by a single signal generator. After applying the first acoustic signal to the AOD at step 230, the single signal generator may switch to generate the second acoustic signal instead of the first acoustic signal, before applying the second acoustic signal to the AOD at step 240.

According to an embodiment of the present disclosure, the laser beam may be a

pulsed laser beam having a pulse width and a time period between laser pulses. The time between applying the first acoustic signal and applying the second acoustic signal may be less than the time period between laser pulses. In other words, steps 230 and 240 may be performed on subsequent laser pulses, such that a first laser pulse has a Gaussian profile and a subsequent laser pulse has a modified profile.

According to an embodiment of the present disclosure, the method 200 may be used for micro-machining processes, such as drilling or cutting holes in a substrate. As shown in FIG. 6, the method 200 may further comprise the following steps.

At step 250, the deflected laser beam is directed toward a stage configured to hold a substrate. The substrate may be a semiconductor wafer, printed circuit board, or other components. When disposed on the stage, the substrate may be positioned in a path of the deflected laser beam. For example, at least a portion of the substrate may be positioned in the path of the deflected laser beam. The deflected laser beam may have the Gaussian profile or the modified profile, depending on which of the first acoustic signal or the second acoustic signal is applied to the AOD.

At step 260, a hole is cut in the substrate with the deflected laser beam. The profile of the deflected laser beam may define the geometry of the hole. For example, a hole cut with a laser beam having a Gaussian profile may differ from a hole cut with a laser beam having a modified profile (e.g., top hat profile). In a case where the modified profile is a multipole profile, a 2-D array of holes (e.g., 2×2, 3×3, 4×4, etc.) may be cut in a single cutting operation, which may further reduce throughput time.

In some embodiments, steps 250 and 260 may be performed after step 230 (without performing step 240). In such a case, the deflected laser beam having the Gaussian profile is used to cut the hole in the substrate.

In some embodiments, steps 250 and 260 may be performed after step 240 (without performing step 230). In such a case, the deflected laser beam having the modified profile is used to cut the hole in the substrate.

In some embodiments, holes may be cut in the substrate using deflected laser beams of different beam shapes. For example, after step 260, step 230 or step 240 may be repeated to change the profile of the deflected laser beam for another cutting operation. As shown in FIG. 8, step 260 may comprise the following steps.

At step 262, the hole is cut in the substrate with the deflected laser beam having the Gaussian profile. It should be understood steps 230 and 250 may be performed before step 262 to produce the deflected laser beam having the Gaussian profile and to direct the beam toward the substrate for a cutting operation.

At step 264, the hole is cut in the substrate with the deflected laser beam having the Gaussian profile. It should be understood that steps 240 and 250 may be performed before step 264 to produce the deflected laser beam having the modified profile and to direct the beam toward the substrate for a cutting operation.

In some embodiments, steps 262 and 264 may be performed on the same hole location on the substrate. For example, step 262 may be performed first for a rough locating cut in the substrate, and step 264 may be performed second for a clean finishing cut on the substrate. Alternatively, steps 262 and 264 may be performed at different locations on the substrate. For example, between steps 262 and 264, the substrate and/or the deflected laser beam may be moved to change the location where the deflected laser beam impacts the substrate. It should be understood that before performing step 262 or 264, the respective one of step 230 or step 240 may be performed to produce the deflected laser beam having the appropriate profile for the cutting operation.

With the method 200, the shape of the deflected laser beam can be controlled easily and quickly by applying different acoustic signals to the AOD. This may increase system flexibility to produce desired beam shapes moving or modifying optics or other system components. In addition, throughput time may be reduced, as beam shape can be changed in microseconds (e.g., between laser pulses), instead of moving optics or moving the positioning system to repeat cutting operations.

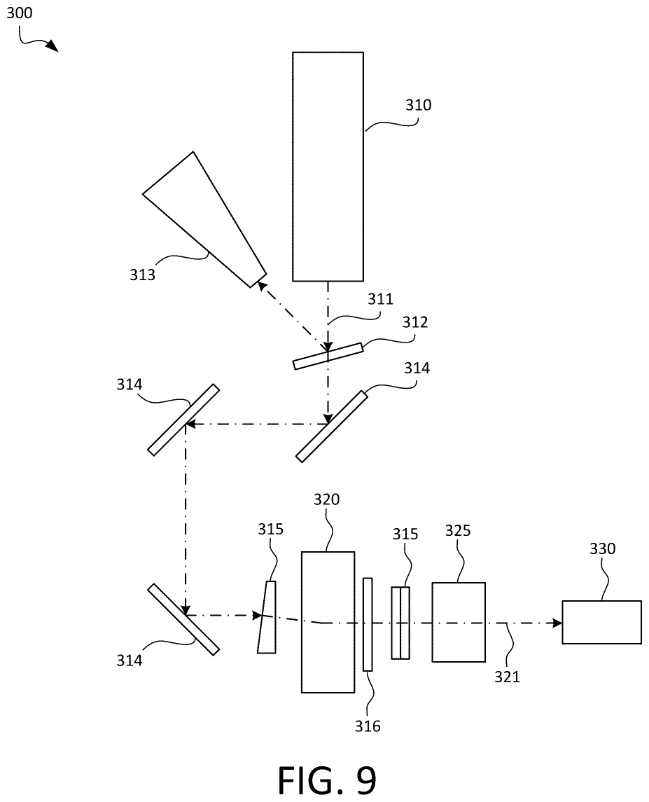

Referring to FIG. 9, an embodiment of the present disclosure provides a system 300. The system 300 may include the components of the system 100, and may be configured to perform the method 200 described in the above embodiments.

The system 300 may comprise a laser generator 310. The laser generator may be configured to generate a laser beam 311. The laser generator 310 may be configured to generate a laser beam 311. The laser generator 310 may have a power of 20 W to 30 W, and may be configured to generate a laser beam 311 having an intensity capable of performing cutting operations on a substrate. The laser generator 310 may be selected based on a material of the substrate sought to be cut. The laser beam 311 may be a pulsed laser beam. The pulsed laser beam may have a pulse width and a time period between laser pulses, which may be set according to a particular application.

An attenuator 312 may be positioned in the path of the laser beam 311. The attenuator 312 may be configured to transmit at least a portion of the laser beam 311 and reflect a portion of the laser beam 311 toward a beam dump 313. The attenuator 312 may have a high power position and a lower power position. The low power position may be used to safely align the setup.

The lower power position may decrease the power of the laser beam 311 transmitted through the attenuator 312 by reflecting a portion of the laser beam 311 toward the beam dump 313. After alignment, the attenuator 312 may be switched to the high power positon, to transmit a selected power of the laser beam 311 through the attenuator 312.

One or more flat mirrors 314 may be positioned in the path of the laser beam 311 downstream or upstream of the attenuator 312. The flat mirrors 314 may be configured to change the direction of the path of the laser beam 311.

The system 300 may further comprise a first an acousto-optical deflector (AOD) 320. The first AOD 320 may be positioned in the path of the laser beam 311 downstream of the attenuator 312 and the one or more mirrors 314. The first AOD 320 may be a crystal that is configured to output a deflected laser beam 321. When an acoustic signal is applied to the first AOD 320, the diffractive grating created in the crystal by the acoustic wave may be modified to adjust the profile of the deflected laser beam 321. For example, a frequency of an acoustic signal may define an angle of the deflected laser beam 321, and an amplitude of an acoustic signal may define an intensity of the deflected laser beam 321. The acoustic signal may propagate through the first AOD 320 and cross an optical aperture of the first AOD 320, through which the laser beam 311 is transmitted.

One or more windows 315 may be positioned on the input and output sides of the first AOD 320, to transmit the laser beam 311 and the deflected laser beam 321, respectively. The windows 315 may have a wedge shape to deflect the laser beam 311 at an angle needed for diffraction on the AOD 320 (i.e., the Bragg angle). The two windows 315 shown in FIG. 9 may be orthogonal to each other. A polarization rotator (PR) 316 may also be positioned on the output side of the first AOD 320, to output the deflected laser beam 321 at an angle orthogonal to the input laser beam 311.

The system 300 may further comprise a second AOD 325. The second AOD may be positioned in the path of the deflected laser beam 321 and may be orthogonal to the first AOD 320. When an acoustic signal is applied to the second AOD 325, the diffractive grating created in the crystal by the acoustic wave may be modified to adjust the profile of the deflected laser beam 321. For example, a frequency of an acoustic signal may define an angle of the deflected laser beam 321, and an amplitude of an acoustic signal may define an intensity of the deflected laser beam 321. The acoustic signal may propagate through the second AOD 325 and cross an optical aperture of the second AOD 325, through which the deflected laser beam 321 is transmitted, after being output from the first AOD 320. It should be understood that the first AOD 320 may deform the laser beam 311 in one dimension only. The second AOD 325 may be configured to deform the laser beam 311 in a second dimension, based on the orthogonal orientation of the first AOD 320 and the second AOD 325. Accordingly, the combination of the first AOD 320 and the second AOD 325 may produce a deflected laser beam 321 having a modified profile that is two-dimensional. In other words, while the first AOD 320 may be used to create any of the profiles shown in FIGS. 3A, 3C, and 3E, the second AOD 325 creates the second dimension of the profiles, as shown in FIGS. 3B, 3D, and 3F. The acoustic signals may be applied to the first AOD 320 and the second AOD by the same signal generator or different signal generators. Each signal generator may be configured to produce at least one acoustic signal having a periodic or freeform waveform.

The system 300 may further comprise a camera 330. The camera 330 may be positioned in the path of the deflected laser beam 321 after the second AOD 325. The camera 330 may be configured to analyze the output deflected laser beam 321 to confirm the modified profile.

The system 300 may comprise any other optical elements. Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a laser generator configured to generate a laser beam;
an acousto-optical deflector (AOD) positioned in a path of the laser beam; and
at least one acoustic signal generator configured to generate at least two acoustic signals comprising a first acoustic signal having a periodic waveform and a second acoustic signal having a freeform waveform;
wherein the at least one acoustic signal generator is further configured to:
apply the first acoustic signal to the AOD to output a deflected laser beam having a Gaussian profile; and
apply the second acoustic signal to the AOD to adjust the Gaussian profile of the deflected laser beam to a modified profile.

2. The system of claim 1, wherein the modified profile comprises a top hat profile or a multi-pole profile.

3. The system of claim 1, wherein the at least one acoustic signal generator comprises:
a first signal generator configured to generate the first acoustic signal; and
a second signal generator configured to generate the second acoustic signal;
wherein the first signal generator and the second signal generator are configured to apply one of the first acoustic signal and the second acoustic signal to the AOD at a time.

4. The system of claim 1, wherein the at least one acoustic signal generator comprises:
a single signal generator configured to generate both the first acoustic signal and the second acoustic signal;
wherein the single signal generator is configured to apply one of the first acoustic signal and the second acoustic signal to the AOD at a time.

5. The system of claim 1, wherein the laser beam is a pulsed laser beam having a time period between laser pulses, and the at least one acoustic signal generator is further configured to:
switch between generating the first acoustic signal and the second acoustic signal during the time period between laser pulses.

6. The system of claim 1, further comprising a stage configured to hold a substrate positioned in a path of the deflected laser beam.

7. The system of claim 1, further comprising a second AOD positioned in the path of the laser beam orthogonal to the AOD, wherein the at least one acoustic signal generator is further configured to apply the first acoustic signal and the second acoustic signal to the second AOD to produce two-dimensional beam profiles.

8. The system of claim 1, wherein the AOD comprises a crystal, and applying the at least two acoustic signals to the crystal modifies a diffractive grating created in the crystal by acoustic waves to output the deflected laser beam having the Gaussian profile and the modified profile.

9. The system of claim 8, wherein a frequency of the at least two acoustic signals defines an angle of the deflected laser beam, and an amplitude of the at least two acoustic signals defines an intensity of the deflected laser beam.

10. The system of claim 9, wherein the freeform waveform has a non-periodic frequency and amplitude that is configured to adjust the Gaussian profile of the deflected laser beam to the modified profile.

11. A method comprising:
directing a laser beam toward an acousto-optical deflector (AOD);
generating at least two acoustic signals comprising a first acoustic signal having a periodic waveform and a second acoustic signal having a freeform waveform;
applying the first acoustic signal to the AOD to output a deflected laser beam having a Gaussian profile; and
applying the second acoustic signal to the AOD to adjust the Gaussian profile of the deflected laser beam to a modified profile.

12. The method of claim 11, wherein the modified profile comprises a top hat profile or a multi-pole profile.

13. The method of claim 11, wherein generating the at least two acoustic signals comprises:
generating the first acoustic signal with a first signal generator; and
generating the second acoustic signal with a second signal generator after applying the first acoustic signal to the AOD.

14. The method of claim 11, wherein generating the at least two acoustic signals comprises:
generating the first acoustic signal and the second acoustic signal with a single signal generator;
wherein after applying the first acoustic signal to the AOD, the single signal generator switches to generate the second acoustic signal instead of the first acoustic signal.

15. The method of claim 11, wherein the laser beam is a pulsed laser beam having a time period between laser pulses, and a time between applying the first acoustic signal to the AOD and applying the second acoustic signal to the AOD is less than the time period between laser pulses.

16. The method of claim 11, further comprising:
directing the deflected laser beam toward a stage configured to hold a substrate; and
cutting a hole in the substrate with the deflected laser beam.

17. The method of claim 16, wherein cutting the hole in the substrate with the deflected laser beam comprises:
cutting the hole in the substrate with the deflected laser beam having the Gaussian profile; and
cutting the hole in the substrate with the deflected laser beam having the modified profile.

18. The method of claim 11, wherein the AOD comprises a crystal and applying the at least two acoustic signals modifies a diffractive grating created in the crystal by acoustic waves to output the deflected laser beam having the Gaussian profile and the modified profile.

19. The method of claim 18, wherein a frequency of the at least two acoustic signals defines an angle of the deflected laser beam, and an amplitude of the at least two acoustic signals defines an intensity of the deflected laser beam.

20. The method of claim 19, wherein the freeform waveform has a non-periodic frequency and amplitude that is configured to adjust the Gaussian profile of the deflected laser beam to the modified profile.
